(19) United States
(12) Patent Application Publication
(10) Pub. No.: US 2017/0206479 A1
(43) Pub. Date: Jul. 20, 2017

(54) WORK STATE ANALYZING SYSTEM

(71) Applicant: NEC Corporation, Tokyo (JP)

(72) Inventors: Rie IWASAKI, Tokyo (JP); Shin NAKAMURA, Tokyo (JP); Yuan LUO, Tokyo (JP); Yuko OHTA, Tokyo (JP)

(21) Appl. No.: 15/326,062

(22) PCT Filed: May 19, 2015
(86) PCT No.: PCT/JP2015/002517

§ 371 Date: Jan. 13, 2017

(30) Foreign Application Priority Data
Jul. 15, 2014 (JP) 2014-144827

(51) Int. Cl. G06Q 10/06

(52) U.S. Cl. CPC G06Q 10/0639

(57) ABSTRACT

A system includes an activity measuring device that measures an activity of a person existing in an area; an output measuring device that measures an output generated by the activity of the person; an activity real state detection unit that detects a current activity state of the person, based on a measurement result by the activity measuring device; an activity optimum state detection unit that detects an optimum activity state from among a plurality of past activity states of the person causing the output to be generated, based on past measurement results by the activity measuring device and the output measuring device; and an activity state mapping unit that generates an analysis result in which the detected current activity state of the person is associated with the optimum activity state.

### TECHNICAL FIELD

The present invention relates to a work state analyzing system, an analysis device, an analysis method, and a program.

### BACKGROUND ART

As first related art of the present invention, mechanically measuring an activity of a person in an area such as an office floor of an office building or a working area in a plant has been proposed (for example, see Patent Document 1). In the first related art, operation logs of a personal computer (PC) used in the work are analyzed, and specifying whether or not each person is operating a PC, and in the case of a PC operation, the work contents are specified according to the type of the operating application. Further, in the first related art, with a temperature sensor provided in an area, the temperature of the area where a person carries out an activity is measured or a predicted mean vote (PMV) is calculated.

Meanwhile, as second related art of the present invention, a system for controlling environment of an area such as a building, with use of facility equipment such as an air conditioner, has been proposed (see Patent Document 2, for example) The second related art includes an energy amount adding means for calculating the energy amount used by a user in an area, an comfortability analyzing means for analyzing the amenity and the activity of the user, and a productivity analyzing means for analyzing the productivity of the user based on calculated energy amount and the analyzed amenity and activity of the user. The productivity analyzing means controls energy consumption amount of a used device such as an air conditioner such that the productivity is increased as much as possible with respect to the target energy amount in the area. Further, in the second related art, information such as a speed of inputting keys of an information processing device used by the user in the area, input frequencies of a Delete key and a Backspace key indicating input errors, and the type of application being used are used as an index of productivity.

Patent Document 1: JP 5514507 B

Patent Document 2: JP 5171885 B

### SUMMARY

Meanwhile, to enhance productivity or work efficiency, it is necessary to improve an activity of a person to be in a better state. In order to do so, however, it is insufficient to simply measure an activity of a person mechanically and present the measurement result to the person or a manager, because it is impossible to objectively check how much the activity state of the person leaves room for improvement.

An exemplary object of the present invention is to provide a work state analyzing system configured to solve the aforementioned problem, that is, a problem that it is difficult to objectively check how much an activity state of a person leaves room for improvement.

A work state analyzing system according to an embodiment of the present invention includes

an activity measuring device that measures an activity of a person existing in an area;

an output measuring device that measures an output generated by the activity of the person;

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and

an activity state mapping unit that generates an analysis result in which the detected current activity state of the person is associated with the optimum activity state.

An analysis device, according to another embodiment of the present invention, is connected with an activity measuring device and an output measuring device. The activity measuring device is configured to measure an activity of a person existing in an area, and the output measuring device is configured to measure an output generated by the activity of the person. The analysis device includes

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and

an activity state mapping unit that generates an analysis result in which the detected current activity state of the person is associated with the optimum activity state.

An analysis method according to another embodiment of the present invention is an analyzing method performed by an analysis device connected with an activity measuring device and an output measuring device. The activity measuring device is configured to measure an activity of a person existing in an area, and the output measuring device is configured to measure an output generated by the activity of the person. The analysis device includes an activity real state detection unit, an activity optimum state detection unit, and an activity state mapping unit. The method includes

by the activity real state detection unit, detecting a current activity state of the person, based on a measurement result by the activity measuring device;

by the activity optimum state detection unit, detecting an optimum activity state from among a plurality of past activity states of the person causing the output to be generated, based on past measurement results by the activity measuring device and the output measuring device; and

by the activity state mapping unit, generating an analysis result in which the detected current activity state of the person is associated with the optimum activity state.

A program according to another embodiment of the present invention causes a computer to function as, the computer being connected with an activity measuring device and an output measuring device, the activity measuring device being configured to measure an activity of a person existing in an area, the output measuring device being configured to measure an output generated by the activity of the person:

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and

an activity state mapping unit that generates an analysis result in which the detected current activity state of the person is associated with the optimum activity state.

As the present invention has the above-described configuration, it is possible to objectively check how much an activity state of a person leaves room for improvement.

### BRIEF DESCRIPTION OF DRAWINGS

FIG. 1 is a block diagram illustrating a configuration of a system according to a first exemplary embodiment of the present invention.

FIG. 2 is a block diagram illustrating a configuration of a system according to a second exemplary embodiment of the present invention.

FIG. 3 is a block diagram illustrating details of an analysis device in the system according to the second exemplary embodiment of the present invention.

FIG. 4 is a block diagram illustrating details of an activity optimum state detection device in the system according to the second exemplary embodiment of the present invention.

FIG. 5 is a flowchart for explaining a flow of processes of the system according to the second exemplary embodiment of the present invention.

FIG. 6 is a block diagram illustrating details of an analysis device in a system according to a third exemplary embodiment of the present invention.

FIG. 7 is a block diagram illustrating details of an analysis device in a system according to a fourth exemplary embodiment of the present invention.

FIG. 8 is a correspondence table of a goal of work, an activity, and an output of the activity, used in a fifth exemplary embodiment of the present invention.

FIG. 9 is a correspondence table of an output, a mapping axis, secondary information used for mapping, and a mapping method, used in the fifth exemplary embodiment of the present invention.

FIG. 10 illustrates an exemplary mapping result in the fifth exemplary embodiment of the present invention.

FIG. 11 illustrates an exemplary mapping result in a sixth exemplary embodiment of the present invention.

FIG. 12 illustrates an exemplary mapping result in a seventh exemplary embodiment of the present invention.

FIG. 13 illustrates an exemplary mapping result in an eighth exemplary embodiment of the present invention.

FIG. 14 is a correspondence table of a goal of work, an activity, and an output of the activity, used in a ninth exemplary embodiment of the present invention.

FIG. 15 is a correspondence table of an output, a mapping axis, secondary information used for mapping, and a mapping method, used in the ninth exemplary embodiment of the present invention.

FIG. 16 illustrates an exemplary mapping result in the ninth exemplary embodiment of the present invention.

FIG. 17 illustrates an exemplary mapping result in a tenth exemplary embodiment of the present invention.

FIG. 18 illustrates an exemplary mapping result in an eleventh exemplary embodiment of the present invention.

### EXEMPLARY EMBODIMENT

Next, exemplary embodiments of the present invention will be described in detail with reference to the drawings.

### First Exemplary Embodiment

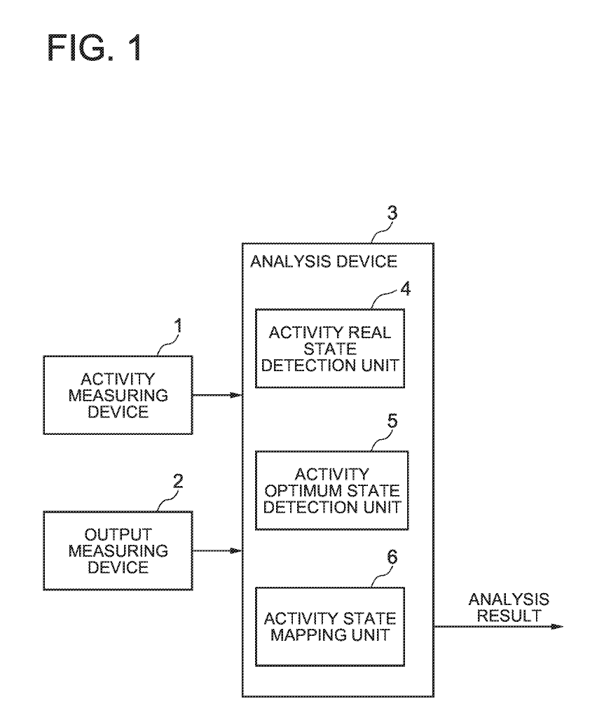

Referring to FIG. 1, a work state analyzing system according to a first exemplary embodiment of the present invention includes an activity measuring device 1, an output measuring device 2, and an analysis device 3.

The activity measuring device 1 has a function of measuring an activity of a person existing in an area not shown. The area may be an area in a building such as an office building, a plant, or a campus, or an area such as an open space or a ground. The output measuring device 2 has a function of measuring an output generated by an activity of a person. The analysis device 3 is connected with the activity measuring device 1 and the output measuring device 2, and has a function of analyzing measurement results provided by them.

The analysis device 3 includes an activity real state detection unit 4, an activity optimum state detection unit 5, and an activity state mapping unit 6.

The activity real state detection unit 4 has a function of detecting a current activity state of a person based on a measurement result by the activity measuring device 1. The activity optimum state detection unit 5 has a function of detecting an optimum activity state from among a plurality of past activity states of a person from which outputs were generated, based on the past measurement results of the activity measuring device 1 and the output measuring device 2. The activity state mapping unit 6 has a function of generating an analysis result in which a current activity state of a person detected by the activity real state detection unit 4 and the optimum activity state detected by the activity optimum state detection unit 5 are associated with each other.

The analyzing system according to the present embodiment configured as described above operates as described below. First, the activity measuring device 1 measures an activity of a person existing in an area, and the output measuring device 2 measures an output generated by the activity of the person. Next, the analysis device 3 analyzes the measurement results of the activity measuring device 1 and the output measuring device 2 to thereby generate an analysis result. Specifically, the activity real state detection unit 4 detects a current activity state of a person based on the measurement result by the activity measuring device 1. Further, the activity optimum state detection unit 5 detects an optimum activity state from among a plurality of past activity states of a person from which outputs were generated, based on past measurement results of the activity measuring device 1 and the output measuring device 2. Then, the activity state mapping unit 6 generates an analysis result in which the current activity state of the person detected by the activity real state detection unit 4 and the optimum activity state detected by the activity optimum state detection unit 5 are associated with each other.

According to the work state analyzing system of the present embodiment, it is possible to objectively check how much the personal activity state leaves room for improvement, because an analysis result, in which a current activity state of a person and an optimum activity state among the past activity states are associated, is generated.

The present invention is based on the configuration described above, and various additions and changes as described below can be made.

An activity tendency measuring device that measures preference in activities of a person may be added, and the activity state mapping unit 6 may generate an analysis result in which the current activity state of the person detected by the activity real state detection unit 4 is associated with the optimum activity state detected by the activity optimum state detection unit 5 and the preference in activities of the person measured by the activity tendency measuring device.

An activity type determination unit that determines, from a goal of work of a person, an activity type of a person measured by the activity measuring device 1 and an output type measured by the output measuring device 2 may be added. The activity type determination unit may be configured to include a table holding a correspondence relationship among a goal of work of a person, an activity type of a person, and an output type, and determine an activity type of a person and an output type held in the table corresponding to the goal of work of the person input from the outside, for example.

A mapping axis determination unit that determines a mapping axis (also called as an analysis axis) that is an analysis viewpoint may be added, and the activity state mapping unit 6 may generate an analysis result in which an activity state according to the determined mapping axis among the current activity states of the person detected by the activity real state detection unit 4 and an optimum activity state according to the determined mapping axis among the optimum activity states of the person detected by the activity optimum state detection unit 5 are associated with each other. The mapping axis determination unit may be configured to include a table holding a corresponding relationship between an output type and a mapping axis, and determine a mapping axis corresponding to an output type determined by the activity type determination unit.

An output analyzing unit that analyzes an output from a predetermined viewpoint may be added, and the activity real state detection unit 4 may detect a result of analyzing, by the output analyzing unit, an output measured by the output measuring device 2 as a current activity state of a person, and the activity optimum state detection unit 5 may detect an analysis result corresponding to an output having the highest evaluation, among the analysis results obtained by analyzing the past outputs of the person by the output analyzing unit, as an optimum activity state of the person.

An output destination analyzing unit that analyzes information of destination to which an output is provided from a predetermined viewpoint may be added, and the activity real state detection unit 4 may detect a result of analyzing, by the output destination analyzing unit, an output measured by the output measuring device 2 as a current activity state of a person, and the activity optimum state detection unit 5 may detect an analysis result corresponding to an output having the highest evaluation among the analysis results obtained by analyzing the past outputs of the person by the output destination analyzing unit, as an optimum activity state of the person.

An analysis result presenting unit that outputs an analysis result generated by the activity state mapping unit 6 may be added.

The analysis device 3 can be realized by a computer configured of a storage unit such as a RAM and a hard disk, a communication interface that performs data communications with the activity measuring device 1 and the output measuring device 2, an operation input unit such as keyboards and a mouse, a screen display unit such as a liquid crystal display, and an arithmetic processing unit such as a microprocessor, for example, connected with the storage unit, the communication interface, the operation input unit, and the screen display unit; and a program stored in the storage unit. The program stored in the storage unit is read when the computer is started or the like, and controls operation of the computer to thereby realize the activity real state detection unit 4, the activity optimum state detection unit 5, and the activity state mapping unit 6 on the computer. The activity type determination unit, the mapping axis determination unit, the output analyzing unit, the output destination analyzing unit, and the analysis result presenting unit may also be realized on the computer in a similar manner

### Second Exemplary Embodiment

### Description of Configurations

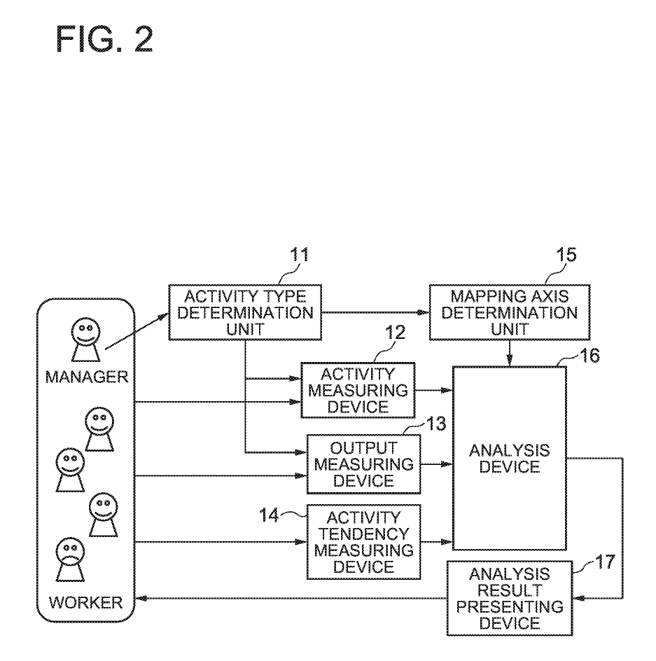

Referring to FIG. 2, a work state analyzing system according to a second exemplary embodiment of the present invention includes an activity type determination unit 11 that receives a goal of work from a manager and determines an activity type and an output to be measured, an activity measuring device 12 that is provided for each activity type and measures an activity of a worker existing in an area, an output measuring device 13 that measures an output, an activity tendency measuring device 14 that measures preference relating to operations performed by a worker, a mapping axis determination unit 15 that determines an axis used for mapping an activity to be measured determined by the activity type determination unit 11, an analysis device 16 that analyzes measurement results using the determined axis, and an analysis result presenting device 17 that outputs an analysis result to a display device or from a printer to thereby present it to a manager or a worker.

The activity type determination unit 11 determines an activity type corresponding to work to be carried out, and an output generated from the activity. Specifically, the activity type determination unit 11 receives a goal of work from a manager and determines an activity type and an output to be measured.

The activity measuring device 12 has a function of measuring the activity determined by the activity type determination unit 11. For example, in the case of measuring an activity of a PC keyboard typing operation, the activity measuring device 12 is implemented by a PC program for taking typing logs, and in the case of measuring the progress of an activity of a program creation operation, the activity measuring device 12 is implemented by a program for reading changes in the content of a program source file and the number of typed lines. Further, in the case of measuring the number of times of meetings, the activity measuring device 12 is realized by a program for extracting meeting schedule data from a scheduler, and the case of measuring the number of times of talking with someone in a day, the activity measuring device 12 is realized by a sensor that continuously acquires the position of a worker by a position sensor and that measures whether the target worker and another worker are at the same position and by a position analyzing system.

The output measuring device 13 measures elements related until an output is generated such as the time taken for creating the output determined by the activity type determination unit 11, the form of the created output, a device used for creating the output, and the members who created the output. If an output is presentation material, the output measuring device 13 acquires, by a program or the like in the PC, the total time taken for preparing material files, a document preparation program used for preparation, co-authors if any, and the like. When schedule information is available, the output measuring device 13 may acquire the time taken for the meetings held before preparation of the output, the members, and the like, in addition to the time and the method used for preparation of the output.

The activity tendency measuring device 14 acquires the subject relating to worker's preference in activities. For example, the activity tendency measuring device 14 may use personality test items used in the Synthetic Personality Inventory (SPI) aptitude test. In the personality test of SPI3 operated currently, inquiries for measuring social introversion, prudence, social relationship aspects, organization adaptability, and the like are prepared. By using such inquiries, the activity tendency measuring device 14 is able to know the characteristics of work activity that the worker feels.

The mapping axis determination unit 15 determines the axis for mapping a worker from the activity type and the output determined by the activity type determination unit 11. The mapping axis is also called as an analysis axis. For example, in the case where the activity type is preparation of presentation material for a client and an output is prepared presentation material, the mapping axis determination unit 15 uses the time taken for preparing the material, the place, used facilities, cooperated workers, and the like as axes for mapping. The number of axes may be one or plural.

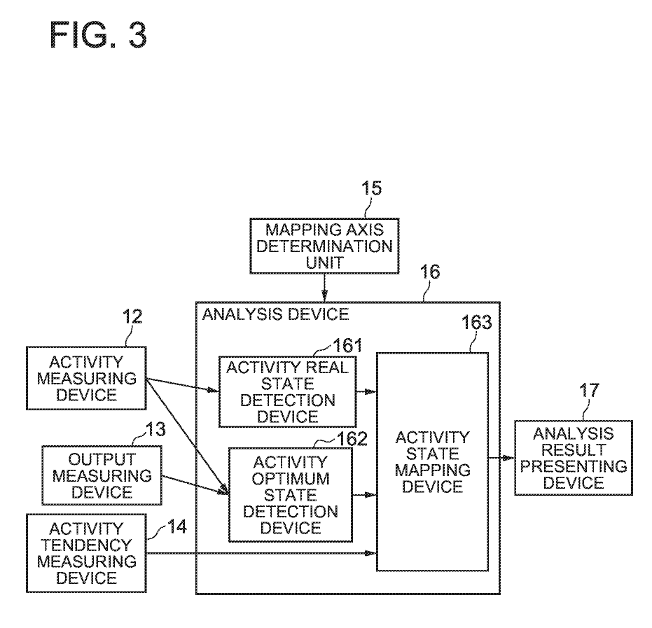

Next, details of the analysis device 16 will be described with reference to FIG. 3. The analysis device 16 includes an activity real state detection device 161, an activity optimum state detection device 162, and an activity state mapping device 163.

The activity real state detection device 161 detects a current activity state from the activity measured by the activity measuring device 12. For example, in the case where the activity to be measured is preparation of presentation material for a client and an output is presentation material, the activity real state detection device 161 detects the time and place used for preparing the presentation material in the current o.

Next, from the measurement result by the activity measuring device 12 and the measurement result by the output measuring device 13, the activity optimum state detection device 162 detects an optimum state for providing an output. In the activity measuring device 12 or the activity optimum state detection device 162, activity data having been measured in the past is stored. Further, in the output measuring device 13 or the activity optimum state detection device 162, past output data is stored. The activity optimum state detection device 162 takes out data of the cases where the same worker prepared presentation material for clients in the past, and detects the working time and the place of the case where presentation material was prepared in the shortest period. The activity optimum state detection device 162 determines whether or not the detected state is optimum depending on the output. The activity optimum state detection device 162 may determine the earliest preparation of an output to be optimum, or may set evaluation indexes for respective outputs and acquire evaluation by a manager on whether or not it is a good output and use it. If the target worker is a new corner to the office or an output to be measured is changed due to a change of job contents, as there is no past output data, the activity optimum state detection device 162 may not detect an optimum state but detect only a current state. If there is data relating to the job before transfer, the activity optimum state detection device 162 may use it as a past output. For example, the activity optimum state detection device 162 may compare the data at the time when the worker prepared presentation material for a client before transfer with the data of the case during preparation of presentation material in the current office to thereby detect that the office before transfer is in the optimum state for the worker but it is not the case currently, for example. Further, in the case where it is possible to use data that the worker has an experience in preparing presentation material for a business division in the office before transfer although the worker does not have an experience in preparing presentation material for a client, or the worker has an experience in presenting demonstrations to a client, the activity optimum state detection device 162 may also use it when mapping the optimum state of the worker or the characteristics of the work activity.

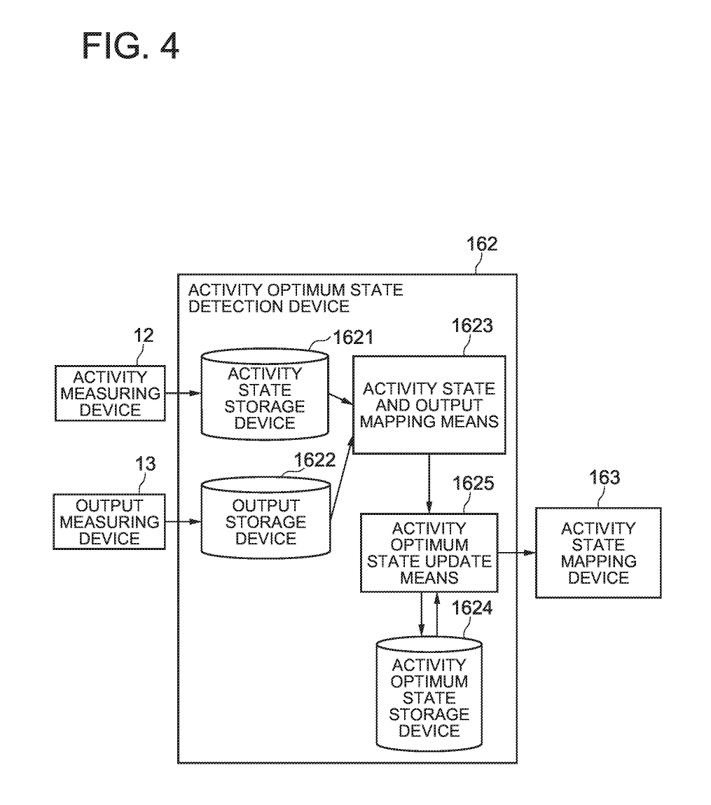

Next, an example of the activity optimum state detection device 162 will be described in detail with reference to FIG. 4. The activity optimum state detection device 162 of this example includes an activity state storage device 1621, an output storage device 1622, an activity state and output mapping means 1623, an activity optimum state storage device 1624, and an activity optimum state update means 1625.

As an example, it is assumed that a target person for detecting an activity optimum state is a worker A, a measurement target activity is preparation of presentation material for a client, and an output is presentation material. In that case, the activity measuring device 12 detects the time, place, and the like used for preparing the presentation material in the current work of the worker A. Further, the output measuring device 13 detects the timing when the worker A prepared the presentation material. The detection results are stored in the activity state storage device 1621 and the output storage device 1622, respectively.

The activity optimum state detection device 162 first performs mapping, by the activity state and output mapping means 1623, of activity state data and output data having the same time stamp or a close time stamp detected for the worker A. For example, it is assumed that the output measuring device 13 measures as follows:

Time: May 10, 2014, 15:00

Output: Presentation material for Company X.doc

Author: A

It is assumed that how to detect an output being provided is defined in the output measuring device 13. For example, it is detected when an output is placed on a given place, registered in an approval system, sent by email to a predetermined member, or the like. Next, it is assumed that the activity measuring device 12 measures as follows regarding the worker A:

Time: May 10, 2014, 13:00-15:00

Place: Meeting room 201

Activity form: Meeting

Members: A, B, C, D

In this case, the activity state and output mapping means 1623 performs mapping as follows:

Mapping result (1)

Activity time: May 10, 2014, 13:00-15:00

Place: Meeting room 201

Activity form: Meeting

Members: A, B, C, D

Output: Presentation material for Company X.doc

Output time: May 10, 2014, 15:00

Author: A

In the activity optimum state storage device 1624, a pair of an activity state regarding the worker A and an output generated therefrom is stored in the same format as that of the mapping result (1). This is the pair regarded as optimum when the activity optimum state detection device 162 performed detection in the past. The activity optimum state update means 1625 extracts data regarding the worker A stored in the activity optimum state storage device 1624, compares the output therein with the mapping result (1) regarding the worker A created currently, to determine which is more optimum. The criterion for determination depends on the case, and is held in the activity optimum state update means 1625. For example, an output in which the activity time is short (quickly prepared output) may be the criterion for a good output. In that case, it is assumed that data of the past optimum state is as follows

Mapping result (2) (Past optimum state)

Activity time: Apr. 23, 2014, 10:00-16:00

Place: Office own desk area 5

Activity form: Individual work

Member: A

Output: Presentation material for Company X.doc

Output time: Apr. 23, 2014, 16:00

Author: A

The activity optimum state update means 1625 compares the mapping results (1) and (2), regards the mapping result (1) having a shorter activity time as an optimum state, transmits it to the activity state mapping device 163, and updates the data in the activity optimum state storage device 1624. This example shows that the worker A works more efficiently in the meeting form rather than individual work when creating the same output.

It should be noted that the timing of processing performed by the activity optimum state detection device 162 may be the same as or different from the processing timing of the activity measuring device 12 that performs measurement in real time or the analysis result presenting device 17 that presents the result. In the case of different timing, the activity optimum state detection device 162 detects and holds optimum states up to the point in advance, and refers to them at the timing of presenting an analysis result to the user. For example, the activity optimum state detection device 162 performs only detection of an activity state and an output regularly. In an asynchronous manner, a superior periodically checks the content of the output and evaluate it. Then, at the time when the superior performs evaluation, the activity optimum state detection device 162 determines an optimum state and stores it in the activity optimum state storage device 1624. Further, as a variation, it is also possible that a person determines an optimum state and directly stores the result in the activity optimum state storage device 1624.

The activity state mapping device 163 maps the three elements, namely the current state detected as described above, the optimum state, and the worker's preference measured by the activity tendency measuring device 14, based on the same criterion according to the axis determined by the mapping axis determination unit 15. In the case where a character test of SPI3 is used by the activity tendency measuring device 14, the activity state mapping device 163 performs mapping after converting the obtained personal character corresponding to the determined axis.

The analysis result presenting device 17 displays the result obtained as described above on the screen of a display device or outputs it from a printing device, to thereby present it to the manager or the worker. The analysis result presenting device 17 may not only present the result but also present an advice for improvement.

### Description of Operation

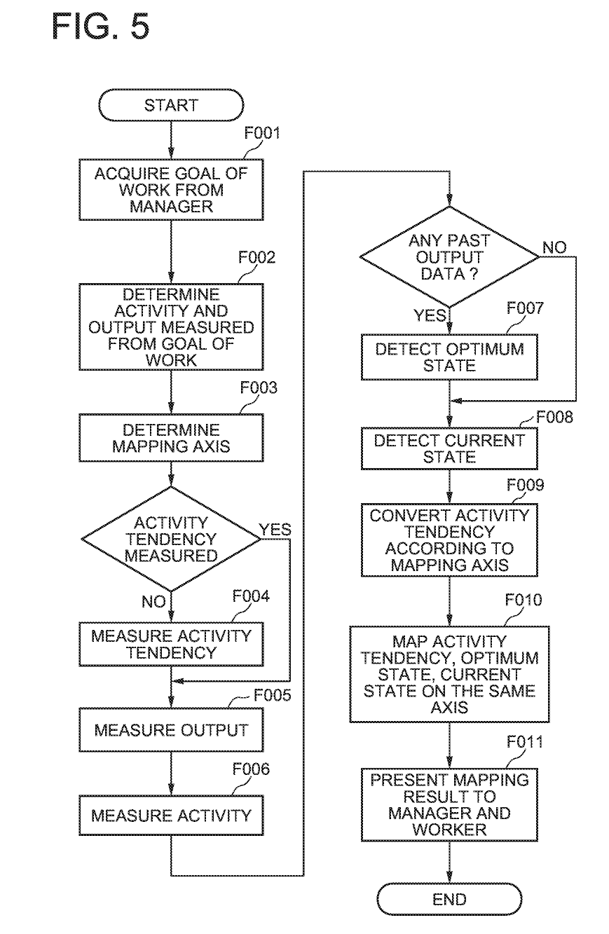

Next, the overall operation of the present embodiment will be described in detail with reference to the flowchart of FIG. 5.

First, the activity type determination unit 11 acquires a goal of work from a manager (step F001), and determines an activity and an output to be measured, corresponding to the goal of work (step F002). Next, the mapping axis determination unit 15 determines an axis for mapping a worker, from the determined activity and the output (step F003). Then, the activity tendency measuring unit 14 reads an activity tendency if it has been measured, and if not, measures an activity tendency (step F004). Then, the output measuring device 13 measures the determined output (step F005). For example, if the output is the number of visits to customers, each time the worker visits someone, the output measuring device 13 performs processing to count and store it. Along with it, the activity measuring device 12 measures the determined activity (step F006). Then, the activity optimum state detection device 162 detects an optimum state (step F007). It should be noted that when there is no output data, that is, an output has not been completed because measurement has just started, for example, detection of an optimum state cannot be detected, so this step is skipped. Then, the activity real state detection device 161 detects the current state based on the data of the activity measured at step F006 (step F008). Then, the activity state mapping device 163 converts the activity tendency measured at step F004 in line with the mapping axis determined at step F003 (step F009), maps the converted activity tendency, the optimum state detected at step F007, and the current state detected at step F008, on the same axis, and generates an analysis result (step F010). Then, the analysis result presenting device 17 presents the analysis result to the manager and the worker (step F011).

As described above, the work state analyzing system of the present embodiment includes the activity type determination unit 11 that determines an activity type and an output according to work carried out in an area, the activity measuring device 12 that, for each activity, measures a work activity of the person existing in the area, the output measuring device 13 that measures an output generated as a result of the activity by the person existing in the area, the activity tendency measuring device 14 that measures a preference in activities of the person existing in the area, the analysis device 16 connected with the activity measuring device 12, the output measuring device 13, and the activity tendency measuring device 14, and the analysis result presenting device 17 that presents the analysis result to the target person or a manager who manages the target person. The analysis device 16 includes the activity real state detection device 161 that detects a current activity state from the activity measured by the activity measuring device 12, the activity optimum state detection device 162 that detects a state where the target person is able to perform an optimum activity from the activity measured by the activity measuring device 12 and the output measured by the output measuring device 13, the mapping axis determination unit 15 that determines an axis for mapping in such a manner that the detected current activity state, the state where the target person is able to carrying out optimum activity, and the preference in activities are comparable, and the activity state mapping device 163 that performs mapping according to the axis determined by the mapping axis determination unit 15.

Then, with the configuration described above, in the work state analyzing system of the present embodiment, the worker or the manager is able to know the current state of a work activity, an optimum activity state where the worker is able to provide the best output, and an activity state that the worker desires. Thereby, the work state analyzing system of the present embodiment can be utilized for work-related management such as allocation of the working time by the worker and team organization by the manager, to thereby be able to realize a state where a better output can be provided.

### Third Exemplary Embodiment

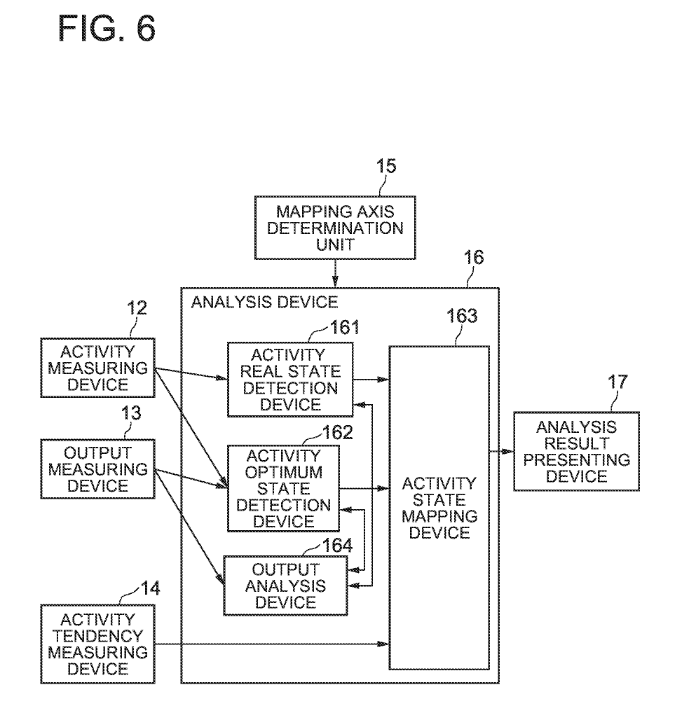

Next, a third exemplary embodiment of the present invention will be described with reference to the drawings. Referring to FIG. 6, in the third exemplary embodiment, an output analysis device 164 is added inside the analysis device 16 of FIG. 3. The second exemplary embodiment is configured to evaluate the process until an output is provided and perform mapping. Meanwhile, in the present embodiment, mapping is performed while evaluating the content of the output itself. For example, in the case where an output is a report, the output analysis device 16 analyzes the worker's preference appeared in the form of the report such that the volume of the explanatory text is large or the volume of the drawings is large, and the activity state mapping device 163 uses the result. By adding such a system of analyzing an output itself, it is possible to perform personnel assignment more efficiently in the case where the specific content or format of an output is set.

### Fourth Exemplary Embodiment

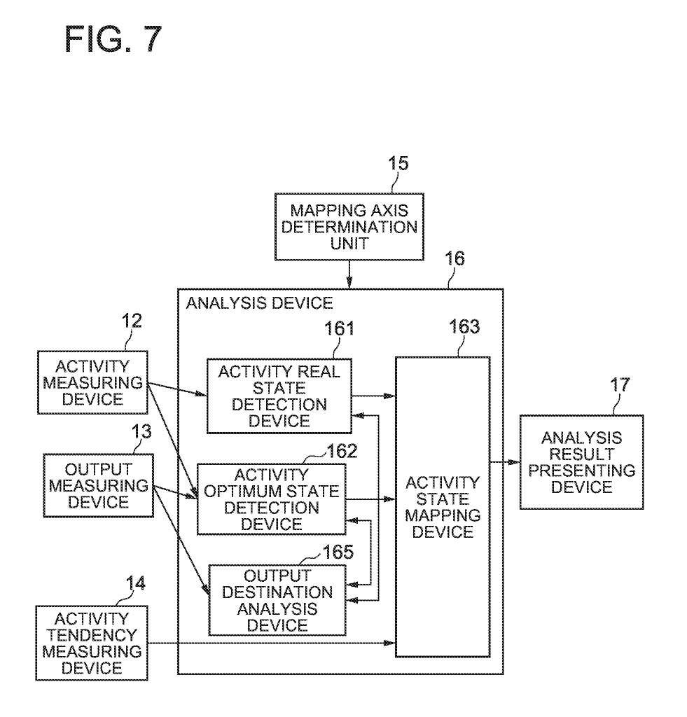

Next, a fourth exemplary embodiment of the present invention will be described with reference to the drawings. Referring to FIG. 7, in the fourth exemplary embodiment, an output destination analysis device 165 is added inside the analysis device 16 of FIG. 3. An output destination represents to whom an output is given, that is, a customer, a delivery destination of an implemented program, or the like, for example. In the present embodiment, by utilizing, for mapping, information regarding the preference of the partner to whom an output is provided or desired information, it is possible to perform personnel assignment for creating an output that is more likely to be accepted, and to perform creation of an output efficiently.

### Fifth Exemplary Embodiment

Next, a fifth exemplary embodiment of the present invention will be described. The fifth exemplary embodiment is one in which the second exemplary embodiment described in reference to FIGS. 2 to 5 is more specified. As an example, it is assumed that a manager of a research division has a goal of work to commercialize the result of a research activity.

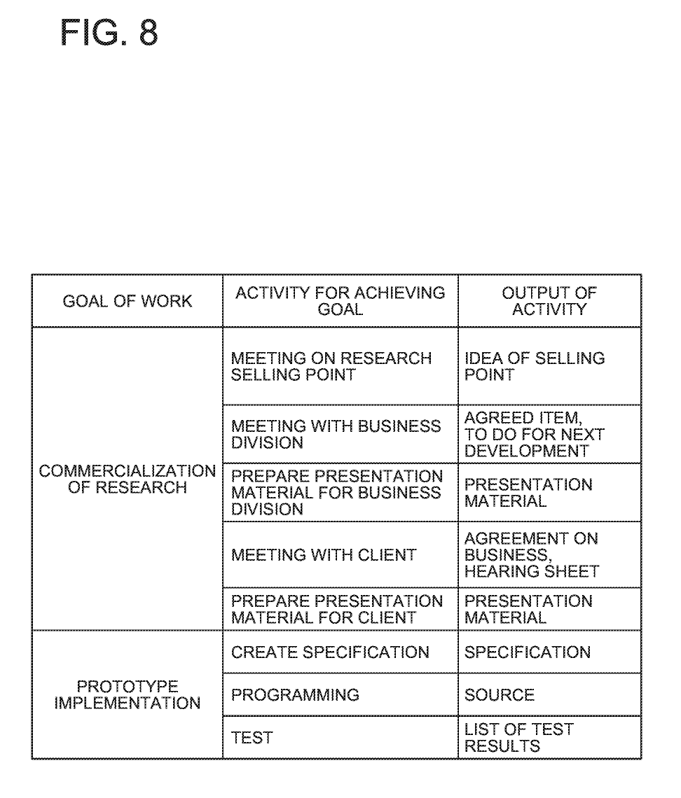

FIG. 8 shows an exemplary correspondence table of a goal of works, activity types for achieving the goal, and outputs of the activities, used by the activity type determination unit 11. For example, the correspondence table shows that commercialization of a research is provided as a goal of work, and activities for achieving it include a meeting on research selling point, a meeting with a business division, preparation of presentation material for the business division, a meeting with a client, and preparation of presentation material for the client. Then, an output of the meeting on the research selling point includes ideas for the selling point, an output of the meeting with a business division includes agreed items and To Do for the next deployment, an output of the preparation of presentation material for the business division includes presentation material, an output of the meeting with a client includes agreements on the business and a survey sheet, and an output of the preparation of presentation material for the client includes presentation material. Further, in the correspondence table of FIG. 8, prototype implementation is shown as another goal of work. Ii is shown that activities for achieving it include preparation of a specification, programming, and testing. Further, an output of the creation of a specification includes a specification, an output of the programming includes a source (program source), and an output of the testing includes a list of test results. Regarding the activities and outputs provided here, all or some of them may be used in the subsequent processing, or only one of them may be selected and used. In this example, it is assumed that commercialization of a research is used as a goal of work, and preparation of presentation material for a business division is used as an activity to achieve the goal, and presentation material as an output thereof is used as a target for measurement.

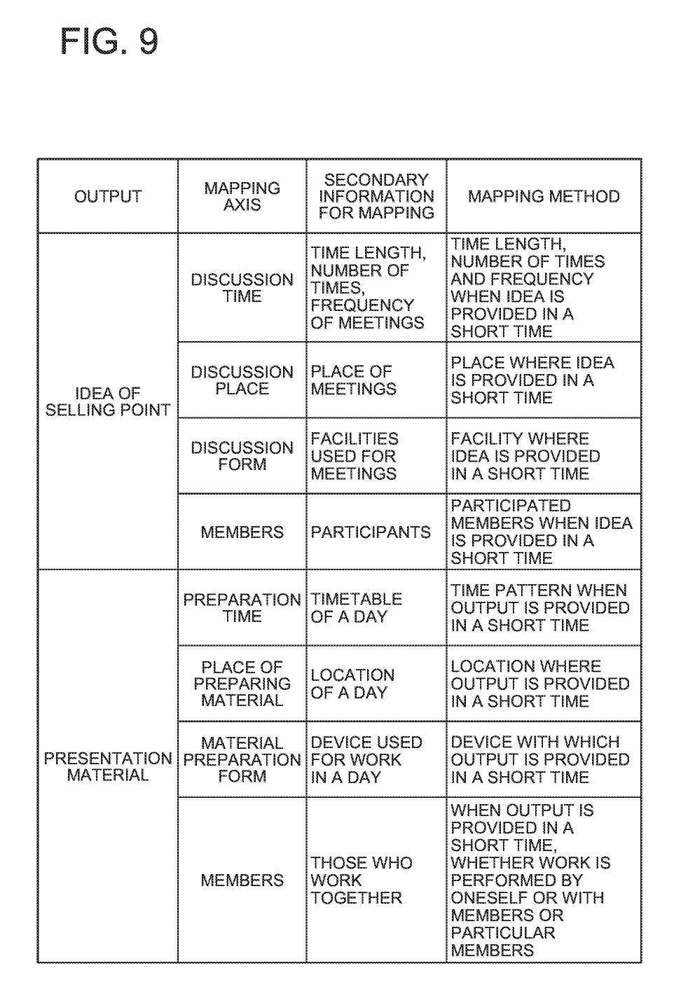

Next, an axis for mapping is determined. FIG. 9 illustrates a correspondence table used by the mapping axis determination unit 15 and the analysis device 16. The correspondence table shows correspondence among outputs, mapping axes, secondary information used for mapping, and mapping methods. Here, secondary information means information obtained by converting the information (primary information) measured by the activity measuring device 12. The correspondence table of FIG. 9 shows that an output includes ideas of the selling point, and mapping axes corresponding thereto include discussion time, discussion places, discussion form, and members (discussion members). In the case where discussion time is used as a mapping axis, a period of time for meetings, the number of times, and the frequency are used as secondary information for the mapping. Further, it is shown that analyzing the time length, the number of times, and the frequency in the case where ideas are presented in a short time, based on the secondary information, is used as a mapping method. In the case where discussion place is used as a mapping axis, the places of the meetings are used as secondary information for the mapping, and it is shown that analyzing the place where ideas are presented in a short time, based on the secondary information, is used as a mapping method. In the case where discussion form is used as a mapping axis, the facilities used in the meetings are used as secondary information for the mapping, and it is shown that analyzing the facility in which ideas are presented in a short time, based on the secondary information, is used as a mapping method. In the case where discussion members are used as a mapping axis, the participants of the meetings are used as secondary information for the mapping, and it is shown that analyzing the members who participate in the meeting when ideas are presented in a short time, based on the secondary information, is used as a mapping method. Further, in the correspondence table of FIG. 9, presentation material is shown as an output, and it is illustrated that mapping axes corresponding thereto include preparation time, places where material is prepared, form of preparing the material, and members. Then, in the case of using preparation time as a mapping axis, a timetable of a day's work is used as secondary information for mapping, and it is shown that analyzing the time pattern when an output is provided in a short time, based on the secondary information, is used as a mapping method. In the case where places of preparing material are used as a mapping axis, the locations in a day are used as secondary information for the mapping, and it is shown that analyzing the location where an output is provided in a short time, based on the secondary information, is used as a mapping method. In the case where the form of preparing material is used as a mapping axis, devices used in a day's work are used as secondary information for the mapping, and it is shown that analyzing the device with which an output is provided in a short time, based on the secondary information, is used as a mapping method. In the case where members are used as a mapping axis, the members of the work are used as secondary information for the mapping, and it is shown that analyzing when an output is provided in a short period, whether the work is performed by his/her own or a plurality of members, or by a particular member, based on the secondary information, is used as a mapping method. That is, FIG. 9 shows a correspondence table describing secondary information to be used and ways of mapping using respective mapping axes. Here, it is assumed that presentation material is used as an output, and the preparation time and the members thereof are used as mapping axes. In this example, while only one mapping axis is used, a plurality of or all of the mapping axes may be used.

When an activity type to be measured is determined by the activity type determination unit 11, the activity measuring device 12 begins measuring of the activity type. In this example, preparation of presentation material for a business division is to be measured. The activity measuring device 12 is able to use logs of document preparation software used for preparation of material to measure the time taken for preparing the document and the co-authors. Further, in addition to the operation time of the document preparation software, the activity measuring device 12 may acquire the time taken for collecting information required for preparation of the material, the time taken for the meetings to determine the policy of preparing the material, and the like, along with the data of the scheduler, and add them as the time taken for preparing the material. Further, in the case of performing measurement on the meetings described in FIG. 8, the activity measuring device 12 measures the period of the meeting, the place, the participants, and the like. The activity measuring device 12 may automatically extract them from the scheduler, or receive them from a participant each time meeting is held. Further, the activity measuring device 12 may also measure time allocation in the meeting. For such measurement, the activity measuring device 12 may acquire voices through a microphone, and analyze the topics to thereby extract transition of the topics, or receive a timetable of the meeting from a participant after the meeting.

The output measuring device 13 begins measurement of the output itself at the same time as measurement of the activity by the activity measuring device 12. In this case, prepared presentation material is an output, and the output measuring device 13 measures the timing when the prescribed output is provided.

Parallel to the measurement of the activity and the output, the activity tendency measuring device 14 measures the activity tendency of a target worker. Here, only a social relationship aspect is used among the items of SPI3 for simplicity. Measurement by the activity tendency measuring device 14 may be performed only at the timing when the system is introduced, or may be performed periodically. If the worker has taken a similar test before, the result may be used.

Next, the activity real state detection device 161 detects the current activity state from the measurement result by the activity measuring device 12 and the mapping axis determined by the mapping axis determination unit 15. The activity measuring device 12 measures a period from the time when the document preparation software is started until it ends, the co-authors, and the like, which are primary information. In order to extract the current activity state and an optimum state from such information and perform mapping, it is necessary to convert it to a kind of secondary information. This has been mentioned in the description regarding the correspondence table of FIG. 9. For example, when the mapping axis is a preparation time, referring to FIG. 9, the secondary information used for mapping is a timetable of a day. As such, the activity real state detection device 161 calculates secondary information such as an average time taken for preparing the document at a time, the number of times used for preparing the document, and the frequency, in the current activity. Thereby, as a current state, it can be detected that preparation of the document is performed once taking a long time, or preparation of the document is dividedly performed several times each taking a short time. Similarly, when the mapping axis is the members, referring to FIG. 9, secondary information used for mapping is those who work together. As such, the activity real state detection device 161 calculates the secondary information such as presence or absence of those who worked together, the number of members, and information about the members, from the primary information such as information about co-authors of the document preparation software and the members of the meetings on the document preparation in the scheduler. Thereby, as a current state, it can be detected that preparation is performed by his/her own, preparation is often performed with co-authors, or the like.

Further, the activity optimum state detection device 162 detects an optimum state for providing an output, from the past measurement results by the activity measuring device 12 and the output measuring device 13 and the mapping axis determined by the mapping axis determination unit 15. Here, it is assumed that an optimum state is defined to be a state where an output is provided in a short time (the total time taken is short). Instead, it is possible that a manager evaluates an output based on a criterion each time an output is provided. The activity optimum state detection device 162 analyzes the secondary information which is the same one as that used by the activity real state detection device 161, for detecting an optimum state for providing the output. Then, the activity real state detection device 161 acquires an analysis result that when preparation is performed once taking a long time, the total time taken is shorter than the case of dividing the preparation in several times, for example.

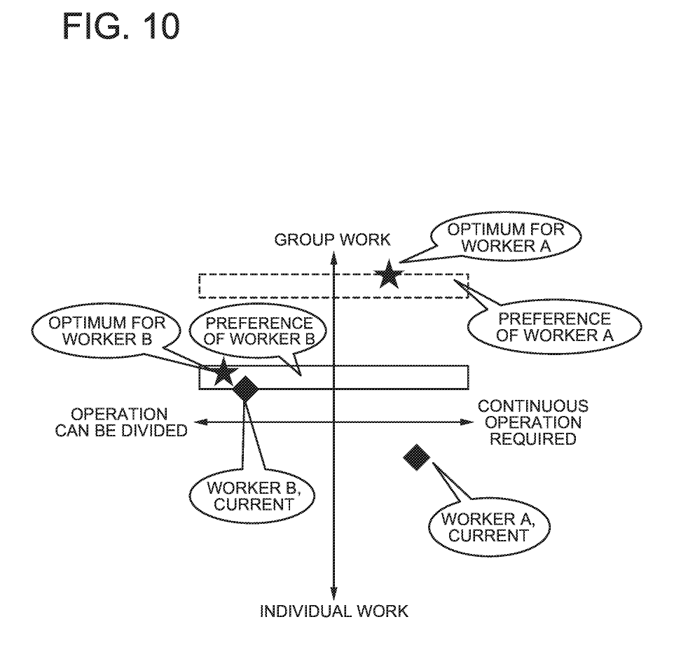

When detection by the activity real state detection device 161 and the activity optimum state detection device 162 and measurement by the activity tendency measuring device 14 are performed, the activity state mapping device 163 maps the current state, the optimum state, and the preference state. FIG. 10 illustrates an example of mapping. In FIG. 10, a rhombus shows the current state, a star shape shows the optimum state, and a rectangular area shows the preference, respectively. First, the current state is one detected from a series of operations relating to the preparation of presentation material currently performed. It is shown that a worker A currently prepares presentation material by his/her own, and he/she tends to take a time continuously. Next, the optimum state of the worker A is one extracted from presentation material preparation activities performed by the worker A in the past. In light of the past examples, the worker A prepares document in the shortest period (most efficiently) when he/she prepares presentation material in a continuous work together with someone, which is plotted at the point of the optimum state. Regarding the preference, in this example, data of a social relationship aspect of SPI3 is used, and it is interpreted as whether or not he/she is suited for group work. As such, it is mapped on the vertical axis. As there is no data corresponding to the horizontal axis, mapping is performed in a band shape in FIG. 10. If it is possible to acquire data regarding the preference corresponding to the horizontal axis through a survey or the like, it is possible to perform mapping in the same manner as the optimum point and the current point.

The analysis result presenting device 17 presents the mapping information of FIG. 10, created in this way, to a manager and the worker. For example, in FIG. 10, the worker A is currently assigned to individual work that the worker is not suited, which suggests a possibility that that the worker may provide a better output when the worker is in a team performing group work. In contrast, regarding a worker B, the current state and the optimum state is close and the preference is also within the band. As such, it is understood that it is better to keep the current state. When the manager sees it, the manager is able to use it for team organization and a change of management. Meanwhile, when the worker sees it, the worker may notice a highly efficient work state that the worker did not know so that the worker can make improvements by himself/herself.

### Sixth Exemplary Embodiment

Next, a sixth exemplary embodiment of the present invention will be described. The present embodiment is one in which the third exemplary embodiment, described with reference to FIG. 6, is more specified. Similar to the case of the fifth exemplary embodiment, it is assumed that a manager of a research division has a goal of work to commercialize a result of research activity.

In the present embodiment, it is defined that a goal of work is commercialization of a research, an activity type for achieving the goal is preparation of presentation material for a business division, and an output of the activity is presentation material, using FIG. 8, similar to the fifth exemplary embodiment. With respect to the information defined, three mapping axes in total, namely the preparation time and the members of presentation material (these two are the same as those of the fifth exemplary embodiment) and the form of presentation material, are used. The form of the presentation material means whether the material includes a large amount of text or a large amount of drawings. The presentation material for a business division includes description of the concept and description of a detailed specification. As such, mapping is performed so as to show a difference between a worker who is good at writing detailed description and a worker who is good at creating an image drawing, for example.

Based on the information described above, the activity measuring device 12, the output measuring device 13, and the activity tendency measuring device 14 perform measurement in a manner similar to that of the fifth exemplary embodiment. The output analysis device 164 shown in FIG. 6 analyzes the content of the output.

The activity real state detection device 161 and the activity optimum state detection device 162 analyze the contents of the output currently being prepared and the stored outputs (presentation material), by the output analysis device 164, in addition to the information shown in the fifth exemplary embodiment, and converts it into secondary information that can be mapped. For example, in the case where presentation material is in PowerPoint form, the number of characters in one page in PowerPoint form is counted, and the number of characters may be mapped, or the amount of image files in one page may be mapped. In this example, it is assumed that the number of characters is counted. In the operation of the activity optimum state detection device 162, a manager may evaluate the result and input it each time a proposal is given to a business division, which may be associated with the form of the output, or a manager may input, in advance, which of detailed description material containing a large amount of characters and conceptual material containing a large amount of pictures is better, based on the next partner to whom a proposal is made. In any way, the activity optimum state detection device 162 detects a form of presentation material of the highest evaluation among pieces of presentation material prepared by the worker, as an optimum state regarding the form of presentation material prepared by the worker.

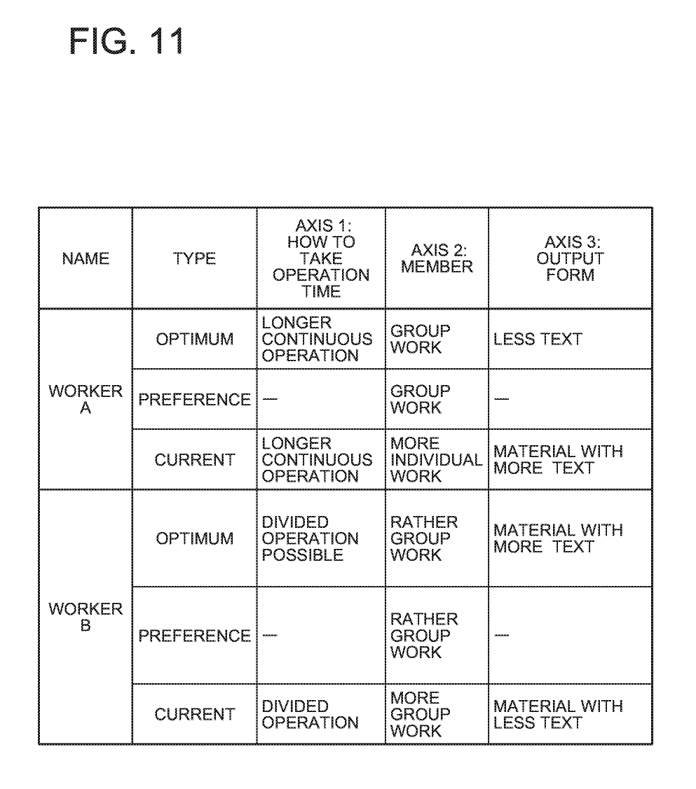

The activity state mapping device 163 performs mapping based on the detection result described above. FIG. 11 illustrates the result thereof. As three axes are used, the result is shown in a table for the sake of visibility. The values with respect to the first axis and the second axis are the same as those shown in FIG. 10 of the fifth exemplary embodiment, and the third axis is added thereto. In this example, the worker A is suited for preparing material containing a small amount of characters (a large amount of images), but is currently preparing material containing a large amount of explanatory notes, while the worker B is the opposite. With use of this information, by assigning opposite material to the worker A and the worker B, each of them can prepare material in a form that the worker is good at doing, and can carry out the operation efficiently.

### Seventh Exemplary Embodiment

Next, a seventh exemplary embodiment will be described. The present embodiment is one in which the fourth exemplary embodiment described with reference to FIG. 7 is more specified. In the present embodiment, it is assumed that a manager of a research department has a goal of work to commercialize the result of a research activity, similar to the fifth exemplary embodiment, and the case where information of a partner to which an output is presented is used as a mapping axis will be described exemplary.

In the present embodiment, it is defined that a goal of work is commercialization of a research, an activity type for achieving the goal is describing the selling point of the research to a customer, and an output of the activity is a describing action. With respect to the information defined here, a mapping axis is set to be a presentation form or a description form (hereinafter simply referred to as a presentation form) that a business division or a customer to be presented prefers when presenting and describing the selling point that is an output to the business division or the customer. Further, as another mapping axis, information regarding to whom description is given is used. As presentation forms, there are a form in which presentation is performed by a person and a form in which presentation is not performed by a person, for example. A form in which presentation is performed by a person includes a personal description form through one-to-one meeting, a one-to-many session form, a one-to-many party form, or the like. A form in which presentation is not performed by a person includes a presentation form utilizing a web site or a social network, a presentation system using an automatic survey form using telephones, placing an advertisement on a newspaper, or the like. A presentation partner includes those who participate in a session, those who accesses the web site, those who are extracted at random and surveyed, or the like. Further, information regarding the presentation partner includes a response rate, or the like.

Based on the information described above, the activity measuring device 12, the output measuring device 13, and the activity tendency measuring device 14 perform measurement similar to that of the fifth exemplary embodiment. The output destination analysis device 165 illustrated in FIG. 7 analyzes the presentation form of the output and the information regarding the presentation partner.

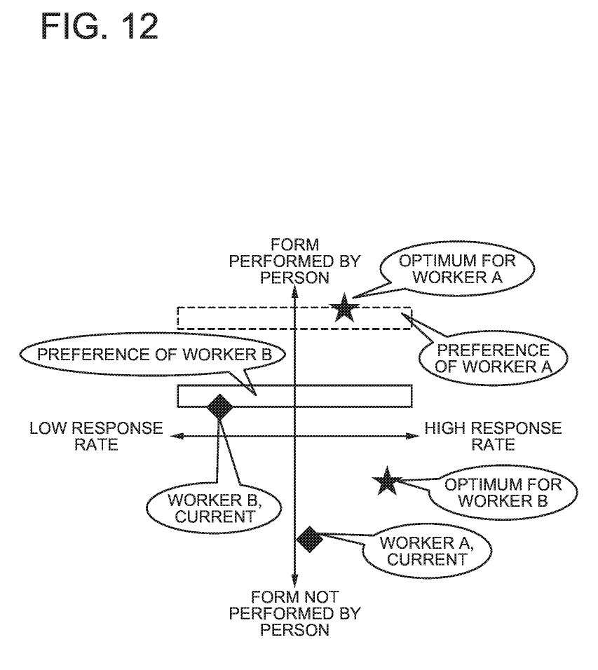

The activity real state detection device 161 uses the output destination analysis device 165 to analyze the current output presentation form and information of the presentation partner to thereby detect an activity real state. Further, the activity optimum state detection device 162 uses the output destination analysis device 165 to analyze the past output presentation forms and information of the presentation partner, and detects an output presentation form and information of the presentation partner having the highest evaluation among them as an activity optimum state. As an evaluation method, the number of inquiries from the output partner or the frequency of responses from the output partner may be used. The activity state mapping device 163 determines an output destination mapping axis corresponding to the analysis result by the output destination analysis device 165, and generates an analysis result in which an activity state according to the output destination mapping axis of the activity states detected by the activity real state detection unit 161 and an optimum activity state according to the output destination mapping axis of the optimum activity states detected by the optimum state detection unit 162 are associated with each other. FIG. 12 illustrates a result of mapping the activity real state and the activity optimum state detected as described above by the activity state mapping device 163. The vertical mapping axis shows whether or not the presentation form is one performed by a person, and the horizontal mapping axis shows whether the response rate is high or low. Here, the response rate collectively represents the number of accesses to a website and the number of survey responses, in a numerical form. For example, it is possible to plot it by setting the target number of accesses or the target number of responses and calculate the percentage of achievement. FIG. 12 shows that the worker A is good at interpersonal presentation and the response rate is higher in interpersonal presentation but the worker now takes an approach such as creation of web advertisements which does not suit him/her. On the other hand, the worker B believes that he/she is good at interpersonal presentation but the result shows that the response rate is higher in an approach rather than interpersonal presentation, actually. As such, the manager or the worker is able to recognize such a situation by the mapping information shown in FIG. 12.

### Eighth Exemplary Embodiment

Next, an eighth exemplary embodiment will be described. The present embodiment shows an example of the case of performing mapping with use of a mapping axis of a worker's skill in a division engaged in program implementation.

In the present embodiment, it is defined that a goal of work is prototype implementation, an activity type for achieving the goal is programming, and an output of the activity is a source (program source), with use of the table of FIG. 8. Two mapping axes will be determined by the mapping axis determination unit 15, namely a source creation time and a worker's skill.

The activity measuring device 12 measures an operation to feed a program by a worker. Similar to the fifth exemplary embodiment, the activity measuring device 12 uses the logs of software used for creating the source to measure the time of feeding the source. It is also possible to add a time taken for the meeting before creation of the source as a time taken for creation of the source, together with the data of the scheduler. The output measuring device 13 measures the timing when the source is completed. Completion in this context may be determined by measuring the time when editing of a file ends, or determined when editing of the entire files ends if the source is configured of a group of files.

A worker's skill is measured by the activity tendency measuring device 14. The worker's skill in this context means program languages that the worker has handled in the past, the total number of lines that the worker has written, and the like. Such a skill may be acquired by using logs for actual program implementation, or acquired by performing a survey to the worker.

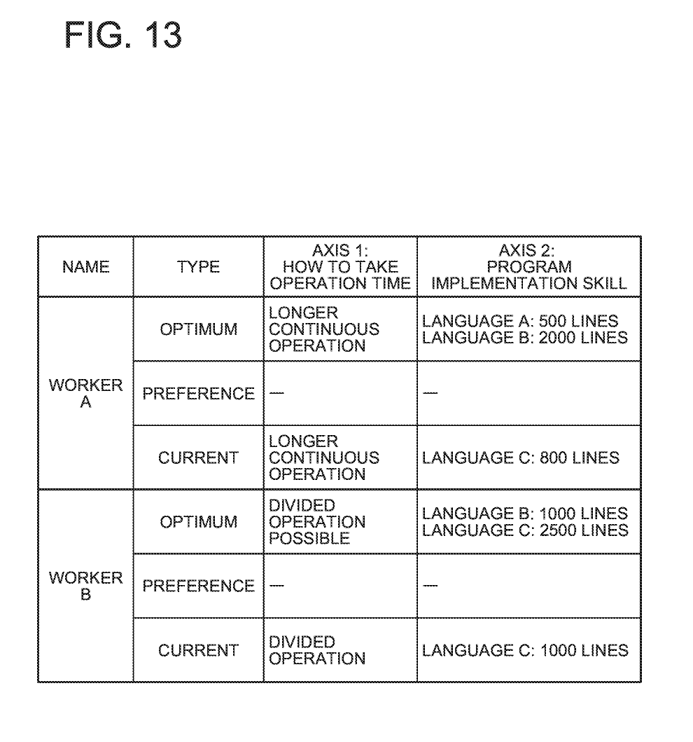

FIG. 13 shows detection results by the activity real state detection device 161 and the activity optimum state detection device 162, and the resultant mapping result by the activity state mapping device 163. The mapping axis 2 relating to the program implementation skill represents the languages that the worker has handled in the past and the total number of lines. In the current row, the language of the current implementation and the total number of lines created up to the current time are shown. This result shows that while both the worker A and the worker B are in a good state regarding the working hours, the worker A performs implementation in a language C that the worker A has not handled before. From this result, the manager can perform management by allowing the worker A and the worker B who has an experience in development in the language C to carry out development in the same group, or recommending the worker A to take a language C development seminar.

### Ninth Exemplary Embodiment

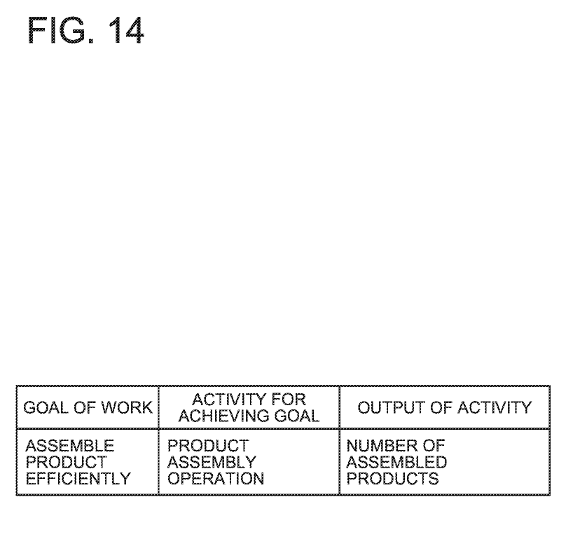

In a ninth exemplary embodiment of the present invention, it is assumed that a manager of a plant, in which a product production activity is performed, has a goal of work to assemble products efficiently. FIG. 14 illustrates an exemplary correspondence table of an activity type and an activity output, to be used by the activity type determination unit 11. In the correspondence table, it is defined that a goal of work is assembling products efficiently, an activity type for achieving the goal is product assembly, and an output of the activity is the number of assembled products. In the below description, a product assembly operation and the output are to be measured.

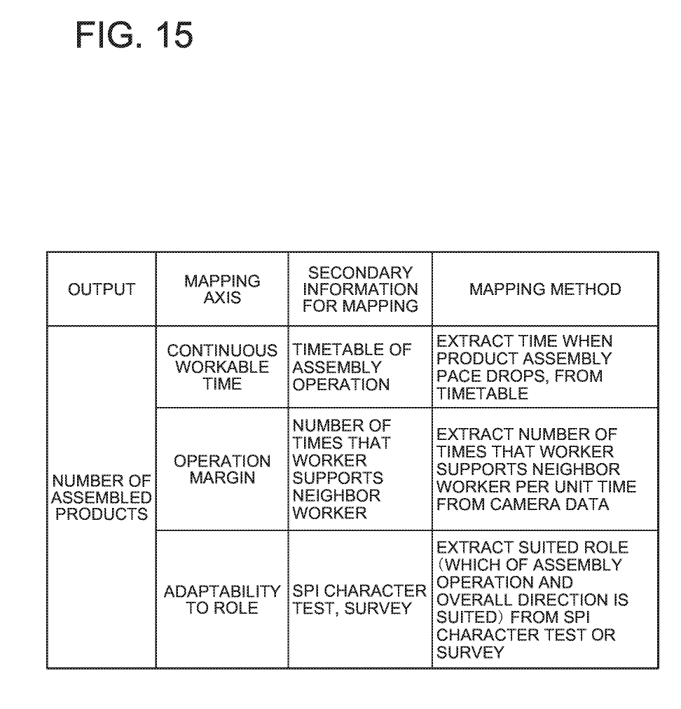

FIG. 15 illustrates an exemplary correspondence table to be used by the mapping axis determination unit 15 and the analysis device 16. The correspondence table shows a correspondence among an output, mapping axes, secondary information used for mapping, and mapping methods. The correspondence table of FIG. 15 shows that the number of assembled products is used as an output, and that mapping axes corresponding thereto include a continuous workable time, an operation margin, and adaptability to the role. Further, it is also shown that when a continuous workable time is used as a mapping axis, a timetable for an assembly operation is secondary information used for mapping, and a mapping method is extracting the time when the product assembly pace drops, based on the secondary information. It is also shown that when an operation margin is used as a mapping axis, the number of times that a worker supports a neighbor worker is secondary information used for mapping, and as a mapping method, acquiring secondary information by extracting the number of times that the worker supports the neighbor worker per unit time from camera data is used. It is also shown that when adaptability to the role is used as a mapping axis, a SPI character test or a survey is secondary information used for mapping, and as a mapping method, extracting a suited role (which of assembly operation and overall direction is suited), based on the secondary information, is used. That is, FIG. 15 shows an exemplary correspondence table in which a mapping axis, secondary information to be used, and how to perform mapping are described. In this embodiment, a continuous workable time, an operation margin, and adaptability to the role are used as mapping axes, for example.

An activity measured by the activity measuring device 12 is a product assembly operation activity. The activity measuring device 12 is able to use a timetable of a product assembly operation to measure the continuous workable time of a worker. Further, the activity measuring device 12 may acquire the number of times that the worker supports a neighbor worker within the continuous workable time, besides completion of the allocated amount, from captured data of the operation site acquired by a camera or the like, and add it as an operation margin.

At the same time as measuring the activity by the activity measuring device 12, the output measuring device 13 begins measurement of an output itself. In this example, an assembled product is an output, and the output measuring device 13 measures the timing that the defined output is provided.

Parallel to measurement of the activity and the output, the activity tendency measuring device 14 measures the activity tendency of a target worker. In this example, a SPI character test or a survey is used, similar to the case of the fifth exemplary embodiment.

Next, the activity real state detection device 161 detects a current activity state from the measurement result by the activity measuring device 12 and the mapping axis determined by the mapping axis determination unit 15. In the case where a continuous workable time is used as a mapping axis, the activity real state detection device 161 extracts the time when the product assembly pace begins to drop, and calculates an average time per continuous assembly operation. Thereby, the activity real state detection device 161 detects, as a current state, whether an assembly operation is a continuous operation of a long time or is performed by being divided into several times of operations of a short time. Similarly, the activity real state detection device 161 extracts the number of times that the worker supports a neighbor worker per unit time from camera data. Thereby, the activity real state detection device 161 acquires the number of time that the worker supports the neighbor worker, besides completion of the own allocations, as the operation margin.

The activity optimum state detection device 162 detects an optimum state for providing the output, from the past measurement results by the activity measuring device 12 and the output measuring device 13 and the mapping axis determined by the mapping axis determination unit 15. Here, it is assumed that an optimum state is defined as that a large number of outputs are provided in a certain period of time. It should be noted that it is also possible to perform evaluation such as a product defective rate.

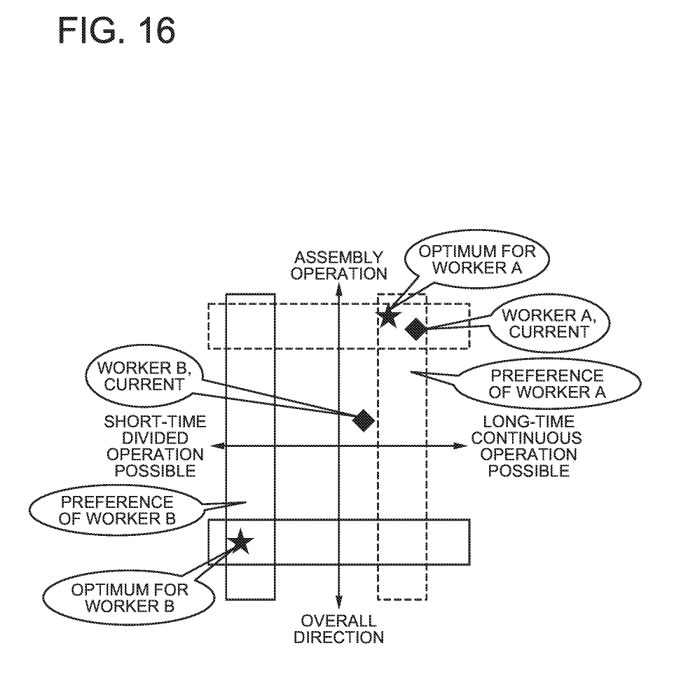

When detection by the activity real state detection device 161 and the activity optimum state detection device 162 and measurement by the activity tendency measuring device 14 are performed as described above, the activity state mapping device 163 maps the current state, the optimum state, and the preference state. FIG. 16 shows an example of mapping. In FIG. 16, a rhombus shows the current state, a star shape shows the optimum state, and a rectangle shows the preference state, respectively. Referring to FIG. 16, it is shown that a worker A currently performs an assembly operation and tends to take a time continuously. The optimum state of the worker A is one extracted from the past assembly operations that the worker A performed. In FIG. 16, based on the extraction result that an operation is performed most efficiently in an assembly operation of a long time obtained from information of the number of assemble products completed within a continuous-time operation by the worker A and the defective rate therein, such a state is plotted at a point of optimum state. Regarding the preference, data of a SPI character test or a survey is used in this example, and whether or not the worker is suited for a continuous long-time operation is mapped on the horizontal axis. It should be noted that on the vertical axis, whether the worker is suited for an assembly operation performed together with others or suited for overall direction to find out problems or perform instruction is mapped.

The mapping information of FIG. 16 created in this manner is presented to the manager and the workers by the analysis result presenting device 17. For example, in FIG. 16, a worker B is currently assigned to a continuous long-time operation that the worker is not suited, which suggests a possibility that a better output may be provided if the worker is assigned to a line where divided short-time operations are carried out. On the contrary, regarding the worker A, as the current state is close to the optimum state and is within the preference band, it is found that the current state should be maintained. When seeing it, the manager is able to use it for organizing the members of an operation line or changing in the management. In the mapping information of FIG. 16, the worker B may suit for overall direction, for example. This suggests a possibility that a better output may be provided if the work is changed from the current assembly operation. It should be noted that when organizing the members of an operation line, in the case of an operation line requiring a continuous long-time assembly operation, it is possible to achieve high efficiency if workers having the same characteristics as the worker A are gathered as much as possible. Further, when the worker sees it, the worker is able to notice an efficient working form that the worker did not know and to make improvement by oneself.

### Tenth Exemplary Embodiment

Next, a tenth exemplary embodiment will be described. The present embodiment describes an example in which a working environment of a worker is used as a mapping axis, in the assembly operation same as that of the ninth exemplary embodiment. Similar to the ninth exemplary embodiment, a goal of work is assembling products efficiently, and an output is an assembled product.

It is assumed that a mapping axis determined by the mapping axis determination unit 15 is temperature. The activity measuring device 12 measures the temperature of the site where a worker performs an activity. Similar to the ninth exemplary embodiment, the output measuring device 13 measures the timing when the defined output (in this case, assembled product) is provided. The activity tendency measuring device 14 measures the subject with respect to the temperature of the worker. This may be measured by requesting a worker to fill in a survey sheet provided at the place of an assembly line to check hot/cold/comfortable from time to time and manually inputting it to the system by a person, or providing a tablet terminal in the place and requesting a worker to answer an electronic survey. The activity tendency measuring device 14 checks the subject input through such a method and the temperature measured by the activity measuring device 12 and detects the temperature that the worker feels most comfortable.

Next, the activity real state detection device 161 extracts the measured current temperature. The activity optimum state detection device 162 detects a temperature optimum for providing an output.

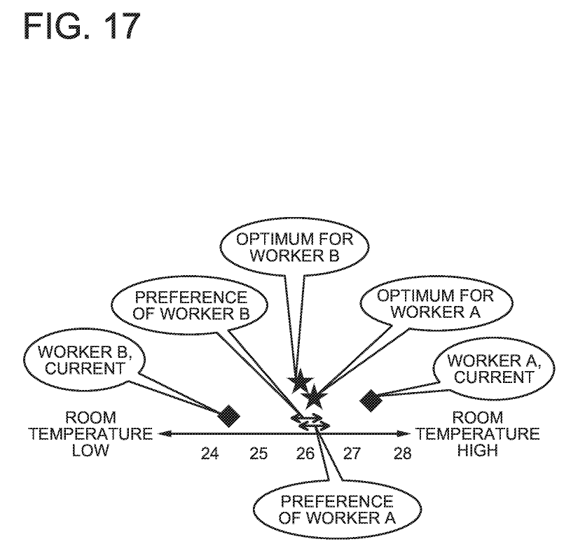

FIG. 17 illustrates a result of mapping by the activity state mapping device 163 with use of the detection result described above. While this example shows a result of one axis in which only temperature is used as a mapping axis for simplicity, another axis relating to the work used in the embodiments described above may also be displayed. In the example of FIG. 17, both a worker A and a worker B prefer temperature of around 27° C. which is also an optimum temperature, but the worker A currently works at a place where he/she feels hot, and the worker B is currently works at a place where he/she feels cold. As such, it is found that the both workers do not work in a state where an output is provided efficiently. In the case of a plant, there is a case where the line is hot or cold depending on the type of facilities, so a manager is able to improve the operational efficiency by assigning a worker to a line where each worker can work comfortably, with use of the mapping result of FIG. 17. Further, by not only assigning workers but also adjusting the temperature of the line according to the workers, it is also possible to improve the efficiency. The analysis result presenting device 17 may present the result as shown in FIG. 17, present the optimum temperature for the worker as well, or present a method of controlling an environment device (air conditioner, heater, or the like) (set temperature or the like) to realize such temperature. While the temperature is used as a mapping axis in this example, the brightness of the light may be used as a mapping axis.

### Eleventh Exemplary Embodiment

Next, an eleventh exemplary embodiment will be described. The present embodiment describes an example of mapping whether or not customer handling is performed smoothly at a cash register (hereinafter simply referred to as a register), in a store such as a convenience store or a supermarket.

In the present embodiment, it is defined that a goal of work is smooth customer handling at the register, and an activity type is a register operation and payment handling. As an activity of handling customers smoothly is efficient handling which provides customer satisfaction, an output is the number of customers handled in the register operation and an average register handling time per customer.

Next, the mapping axis determination unit 15 determines a mapping axis. As an axis which should be considered for mapping a worker, a register operation ability characteristic (whether or not the worker is able to perform register operation quickly and accurately) and the adaptability of a worker to an interpersonal service with respect to a customer are considered. As such, these are determined as two axes.

The activity measuring device 12 measures the operation that the worker performs at the register. Specifically, the activity measuring device 12 extracts a key typing speed, an average input time per item, an average handling time per customer, irregularities in average input time and average handling time, the number of handled customers per unit time, and a continuous counter handling time, and the like, from the logs of the register. Further, the activity measuring device 12 may capture the handling state at the register by a video camera. The output measuring device 13 measures that handling of one customer is finished. For example, the output measuring device 13 may measure that a key indicating completion of payment is pressed from the logs of the register, or measure that a new basket is placed on the table by attaching a sensor to a basket used for register operation. The adaptability of the worker is measured using a SPI character test by the activity tendency measuring device 14.

The activity real state detection device 161 and the activity optimum state detection device 162 convert data measured by the activity measuring device 12 into secondary data that can be mapped. For example, the activity real state detection device 161 and the activity optimum state detection device 162 may convert the measurement result into numerals as simple task fitness of the worker to the register operation. Further, the activity real state detection device 161 and the activity optimum state detection device 162 are able to convert accuracy with respect to the register operation into numerals from the number of correction inputs in the register operation and product reading intervals of the POS system. The activity state mapping device 163 plots whether or not both the simple task fitness and the register operation accuracy are high, on the axis of ability characteristic of the register work. Regarding the worker's adaptability to an interpersonal service, the activity state mapping device 163 may extract whether the worker suits or does not suit communications with people from a SPI character test or analysis of facial expressions in the videos, or extract communication frequency with customers from the video images. Further, the activity state mapping device 163 may take a numerical value of social relationship aspect and a numerical value of fitness to the duty from the SPI character test, take the number of communications with customers at the register from the videos, and take communication aptitude (degree of customer satisfaction) appearing in the facial expressions of customers from the videos, and add the three factors as composite indexes and convert the resultant into numerals, or use them separately.

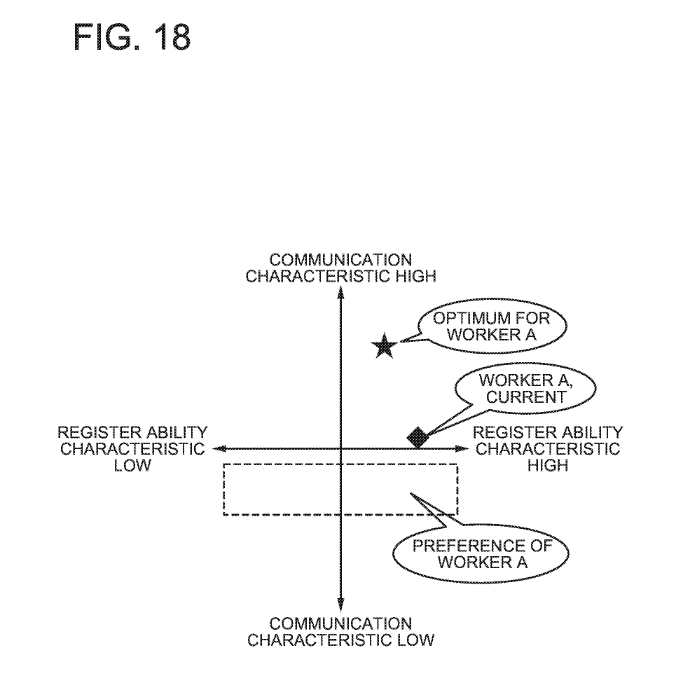

FIG. 18 illustrates an exemplary mapping result. In FIG. 18, the worker A believes that he/she has poor communication characteristic, and the current value shows that the register operation ability is high but the communication characteristic is low. However, from the past output tendency, it is shown that it is optimum (better output is provided as a result) when the worker payed attention to customers rather than performing register operation. For example, when a manager of register operation sees this result, it is possible to utilize it to improve the output by carrying out management such as allowing the worker A to take interpersonal communication education or the like.

While the present invention has been described with reference to the exemplary embodiments described above, the present invention is not limited to the above-described embodiments. The form and details of the present invention can be changed within the scope of the present invention in various manners that can be understood by those skilled in the art.

It should be noted that the present invention is based upon and claims the benefit of priority from Japanese patent application No. 2014-144827, filed on Jul. 15, 2014, the disclosure of which is incorporated herein in its entirety by reference.

### INDUSTRIAL APPLICABILITY

The present invention is widely applicable to places and organizations where people work and perform operation, such as offices, plants, and shops.

The whole or part of the exemplary embodiments disclosed above can be described as, but not limited to, the following supplementary notes.

### Supplementary Note 1

A work state analyzing system comprising:

an activity measuring device that measures an activity of a person existing in an area;

an output measuring device that measures an output generated by the activity of the person;

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and

an activity state mapping unit that generates an analysis result in which the detected current activity state of the person is associated with the optimum activity state.

### Supplementary Note 2

The work state analyzing system according to supplementary note 1, further comprising an activity tendency measuring device that measures preference in activities of the person, wherein

the activity state mapping unit generates an analysis result in which the current activity state of the person is associated with the optimum activity state and the preference in activities of the person.

### Supplementary Note 3

The work state analyzing system according to supplementary note 1 or 2, further comprising

an activity type determination unit that determines a type of the activity of the person measured by the activity measuring device and a type of the output measured by the output measuring device, from a goal of work of the person.

### Supplementary Note 4

The work state analyzing system according to supplementary note 3, wherein

the activity type determination unit includes a table holding a correspondence relationship among the goal of work of the person, the type of the activity of the person, and the type of the output, and determines the type of the activity of the person and the type of the output held in the table corresponding to the goal of work of the person input from the outside.

### Supplementary Note 5

The work state analyzing system according to any of supplementary notes 1 to 4, further comprising

a mapping axis determination unit that determines a mapping axis that is a viewpoint of analysis, wherein

the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

### Supplementary Note 6

The work state analyzing system according to supplementary note 1, further comprising

an output analyzing unit that analyzes the output from a predetermined viewpoint, wherein

the activity real state detection unit detects, as the current activity state of the person, a result of analyzing, by the output analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output analyzing unit.

### Supplementary Note 7

The work state analyzing system according to supplementary note 1, further comprising

an output destination analyzing unit that analyzes information of a destination to which the output is provided, from a predetermined viewpoint, wherein

the activity real state detection unit detects, as the current activity state of the person, a result obtained by analyzing, by the output destination analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output destination analyzing unit.

### Supplementary Note 8

The work state analyzing system according to supplementary note 1, further comprising

an output destination analyzing unit that analyzes information of a destination to which the output is provided, wherein

the activity state mapping unit determines an output destination mapping axis corresponding to an analysis result of the output destination analyzing unit, and generates the analysis result in which an activity state according to the output destination mapping axis, among the current activity states of the person detected by the activity real state detection unit, and an optimum activity state according to the output destination mapping axis, among the optimum activity states of the person detected by the activity optimum state detection unit, are associated with each other.

### Supplementary Note 9

The work state analyzing system according to any of supplementary notes 1 to 8, further comprising an analysis result presenting unit that outputs the analysis result.

### Supplementary Note 10

An analysis device connected with an activity measuring device and an output measuring device, the activity measuring device being configured to measure an activity of a person existing in an area, the output measuring device being configured to measure an output generated by the activity of the person, the analysis device comprising:

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and
an activity state mapping unit that generates an analysis result in which the detected current activity state of the person is associated with the optimum activity state.

### Supplementary Note 11

The analysis device according to supplementary note 10, wherein

the analysis device is connected with an activity tendency measuring device that measures preference in activities of the person, and

the activity state mapping unit generates an analysis result in which the current activity state of the person is associated with the optimum activity state and the preference in activities of the person.

### Supplementary Note 12

The analysis device according to supplementary note 10 or 11, wherein

the analysis device is connected with a mapping axis determination unit that determines a mapping axis that is a viewpoint of analysis, and

the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

### Supplementary Note 13

The analysis device according to supplementary note 10, further comprising

an output analyzing unit that analyzes the output from a predetermined viewpoint, wherein

the activity real state detection unit detects, as the current activity state of the person, a result of analyzing, by the output analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output analyzing unit.

### Supplementary Note 14

The analysis device according to supplementary note 10, further comprising

an output destination analyzing unit that analyzes information of a destination to which the output is provided, from a predetermined viewpoint, wherein

the activity real state detection unit detects, as the current activity state of the person, a result obtained by analyzing, by the output destination analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output destination analyzing unit.

### Supplementary Note 15

The analysis device according to supplementary note 10, further comprising

an output destination analyzing unit that analyzes information of a destination to which the output is provided, wherein

the activity state mapping unit determines an output destination mapping axis corresponding to an analysis result of the output destination analyzing unit, and generates the analysis result in which an activity state according to the output destination mapping axis, among the current activity states of the person detected by the activity real state detection unit, and an optimum activity state according to the output destination mapping axis, among the optimum activity states of the person detected by the activity optimum state detection unit, are associated with each other.

### Supplementary Note 16

The analysis device according to any of supplementary notes 10 to 15, wherein

the activity state mapping device outputs the analysis result to an analysis result presenting unit.

### Supplementary Note 17

A work state analyzing method performed by an analysis device connected with an activity measuring device and an output measuring device, the activity measuring device being configured to measure an activity of a person existing in an area, the output measuring device being configured to measure an output generated by the activity of the person, the analysis device including an activity real state detection unit, an activity optimum state detection unit, and an activity state mapping unit, the method comprising;

by the activity real state detection unit, detecting a current activity state of the person, based on a measurement result by the activity measuring device;

by the activity optimum state detection unit, detecting an optimum activity state from among a plurality of past activity states of the person causing the output to be generated, based on past measurement results by the activity measuring device and the output measuring device; and

by the activity state mapping unit, generating an analysis result in which the detected current activity state of the person is associated with the optimum activity state.

### Supplementary Note 18

The work state analyzing method according to supplementary note 17, wherein

the analysis device is connected with an activity tendency measuring device that measures preference in activities of the person, and

the activity state mapping unit generates an analysis result in which the current activity state of the person is associated with the optimum activity state and the preference in activities of the person.

### Supplementary Note 19

The work state analyzing method according to supplementary note 17 or 18, wherein

the analysis device is connected with a mapping axis determination unit that determines a mapping axis that is a viewpoint of analysis, and

the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

### Supplementary Note 20

The work state analyzing method according to supplementary note 17, wherein

the analysis device includes an output analyzing unit,

the output analyzing unit analyzes the output from a predetermined viewpoint,

the activity real state detection unit detects, as the current activity state of the person, a result of analyzing, by the output analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output analyzing unit.

### Supplementary Note 21

The work state analyzing method according to supplementary note 17, wherein

the analysis device includes an output destination analyzing unit,

the output destination analyzing unit analyzes information of a destination to which the output is provided, from a predetermined viewpoint,

the activity real state detection unit detects, as the current activity state of the person, a result obtained by analyzing, by the output destination analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output destination analyzing unit.

### Supplementary Note 22

The work state analyzing method according to supplementary note 17, wherein

the analysis device includes an output destination analyzing unit,

the output destination analyzing unit analyzes information of a destination to which the output is provided,

the activity state mapping unit determines an output destination mapping axis corresponding to an analysis result of the output destination analyzing unit, and generates the analysis result in which an activity state according to the output destination mapping axis, among the current activity states of the person detected by the activity real state detection unit, and an optimum activity state according to the output destination mapping axis, among the optimum activity states of the person detected by the activity optimum state detection unit, are associated with each other.

### Supplementary Note 23

The work state analyzing method according to any of supplementary notes 17 to 22, wherein

the activity state mapping device outputs the analysis result to an analysis result presenting unit.

### Supplementary Note 24

A program for causing a computer to function as, the computer being connected with an activity measuring device and an output measuring device, the activity measuring device being configured to measure an activity of a person existing in an area:

an activity real state detection unit that detects a current activity state of the person, based on a measurement result by the activity measuring device;

an activity optimum state detection unit that detects an optimum activity state from among a plurality of past activity states of the person causing the output to be generated, based on past measurement results by the activity measuring device and the output measuring device; and

an activity state mapping unit that generates an analysis result in which the detected current activity state of the person is associated with the optimum activity state.

### Supplementary Note 25

The program according to supplementary note 24, wherein

the computer is connected with an activity tendency measuring device that measures preference in activities of the person, and

the activity state mapping unit generates an analysis result in which the current activity state of the person is associated with the optimum activity state and the preference in activities of the person. cl Supplementary Note 26

The program according to supplementary note 24 or 25, wherein

the computer is connected with a mapping axis determination unit that determines a mapping axis that is a viewpoint of analysis, and

the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

### Supplementary Note 27

The program according to supplementary note 24, further causing the computer to function as t an output analyzing unit that analyzes the output from a predetermined viewpoint, wherein

the activity real state detection unit detects, as the current activity state of the person, a result of analyzing, by the output analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output analyzing unit.

### Supplementary Note 28

The program according to supplementary note 24, further causing the computer to function as an output destination analyzing unit that analyzes information of a destination to which the output is provided, from a predetermined viewpoint, wherein

the activity real state detection unit detects, as the current activity state of the person, a result obtained by analyzing, by the output destination analyzing unit, the output measured by the output measuring device, and

the activity optimum state detection unit detects, as the optimum activity state of the person, an analysis result corresponding to the output of highest evaluation among a plurality of analysis results obtained by analyzing a plurality of past outputs of the person by the output destination analyzing unit.

### Supplementary Note 29

The program according to supplementary note 24, further causing the computer to function as an output destination analyzing unit that analyzes information of a destination to which the output is provided, wherein

the activity state mapping unit determines an output destination mapping axis corresponding to an analysis result of the output destination analyzing unit, and generates the analysis result in which an activity state according to the output destination mapping axis, among the current activity states of the person detected by the activity real state detection unit, and an optimum activity state according to the output destination mapping axis, among the optimum activity states of the person detected by the activity optimum state detection unit, are associated with each other.

### Supplementary Note 30

The program according to any of supplementary notes 24 to 29, wherein

the activity state mapping device outputs the analysis result to an analysis result presenting unit.

### REFERENCE NUMERALS

11 activity type determination unit

12 activity measuring device

13 output measuring device

14 activity tendency measuring device

15 mapping axis determination unit

16 analysis device

161 activity real state detection device

162 activity optimum state detection device

163 activity state mapping device

164 output analysis device

165 output destination analysis device

17 analysis result presenting device

1.-10. (canceled)

11. A work state analyzing system implemented by a computer, the computer comprising:
an activity measuring device configured to measure an activity of a person existing in an area;
an output measuring device configured to measure an output generated by the activity of the person;
an activity real state detection unit configured to detect a current activity state of the person, based on a measurement result by the activity measuring device;
an activity optimum state detection unit configured to detect an optimum activity state from among a plurality of past activity states of the person causing the output to be generated, based on past measurement results by the activity measuring device and the output measuring device; and
an activity state mapping unit configured to generate an analysis result in which the detected current activity state of the person is associated with the optimum activity state.

12. The work state analyzing system according to claim 11, wherein
the computer further comprises an activity tendency measuring device configured to measure preference in activities of the person, and
the activity state mapping unit generates an analysis result in which the current activity state of the person is associated with the optimum activity state and the preference in activities of the person.

13. The work state analyzing system according to claim 11, wherein
the computer further comprises an activity type determination unit configured to determine a type of the activity of the person measured by the activity measuring device and a type of the output measured by the output measuring device, from a goal of work of the person.

14. The work state analyzing system according to claim 13, wherein
the activity type determination unit includes a table holding a correspondence relationship among the goal of work of the person, the type of the activity of the person, and the type of the output, and determines the type of the activity of the person and the type of the output held in the table corresponding to the goal of work of the person input from the outside.

15. The work state analyzing system according to claim 11, wherein
the computer further comprises a mapping axis determination unit configured to determine a mapping axis that is a viewpoint of analysis, and
the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

16. The work state analyzing system according to claim 11, wherein
the computer further comprises an output analyzing unit configured to analyze the output from a predetermined viewpoint,
the activity real state detection unit detects, as the current activity state of the person, a result of analyzing, by the output analyzing unit, the output measured by the output measuring device, and
the activity optimum state detection unit detects, as the optimum activity state of the person, an analysis result corresponding to the output of highest evaluation among a plurality of analysis results obtained by analyzing a plurality of past outputs of the person by the output analyzing unit.

17. The work state analyzing system according to claim 11, wherein
the computer further comprises an output destination analyzing unit configured to analyze information of a destination to which the output is provided, from a predetermined viewpoint,
the activity real state detection unit detects, as the current activity state of the person, a result obtained by analyzing, by the output destination analyzing unit, the output measured by the output measuring device, and
the activity optimum state detection unit detects, as the optimum activity state of the person, an analysis result corresponding to the output of highest evaluation among a plurality of analysis results obtained by analyzing a plurality of past outputs of the person by the output destination analyzing unit.

18. The work state analyzing system according to claim 11, wherein
the computer further comprises an output destination analyzing unit configured to analyze information of a destination to which the output is provided, and
the activity state mapping unit determines an output destination mapping axis corresponding to an analysis result of the output destination analysis unit, and generates the analysis result in which an activity state according to the output destination mapping axis, among the current activity states of the person detected by the activity real state detection unit, and an optimum state according to the output destination mapping axis, among the optimum activity states of the person detected by the activity optimum state detection unit, are associated with each other.

19. The work state analyzing system according to claim 11, wherein
the computer further comprises an analysis result presenting unit configured to output the analysis result.

20. An analysis device implemented by a computer, wherein
the computer is connected with an activity measuring device and an output measuring device, the activity measuring device being configured to measure an activity of a person existing in an area, the output measuring device being configured to measure an output generated by the activity of the person, and
the computer comprises:
an activity real state detection unit configured to detect a current activity state of the person, based on a measurement result by the activity measuring device;
an activity optimum state detection unit configured to detect an optimum activity state from among a plurality of past activity states of the person causing the output to be generated, based on past measurement results by the activity measuring device and the output measuring device; and
an activity state mapping unit configured to generate an analysis result in which the detected current activity state of the person is associated with the optimum activity state.

21. The analysis device according to claim 20, wherein
the computer is connected with an activity tendency measuring device configured to measure preference in activities of the person, and
the activity state mapping unit generates an analysis result in which the current activity state of the person is associated with the optimum activity state and the preference in activities of the person.

22. The analysis device according to claim 20, wherein
the computer is connected with a mapping axis determination unit configured to determine a mapping axis that is a viewpoint of analysis, and
the activity state mapping unit generates an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

23. The analysis device according to claim 20, wherein
the computer further comprises an output analyzing unit configured to analyze the output from a predetermined viewpoint,
the activity real state detection unit detects, as the current activity state of the person, a result of analyzing, by the output analyzing unit, the output measured by the output measuring device, and
the activity optimum state detection unit detects, as the optimum activity state of the person, an analysis result corresponding to the output of highest evaluation among a plurality of analysis results obtained by analyzing a plurality of past outputs of the person by the output analyzing unit.

24. The analysis device according to claim 20, wherein
the computer further comprises an output destination analyzing unit configured to analyze information of a destination to which the output is provided, from a predetermined viewpoint,
the activity real state detection unit detects, as the current activity state of the person, a result obtained by analyzing, by the output destination analyzing unit, the output measured by the output measuring device, and
the activity optimum state detection unit detects, as the optimum activity state of the person, an analysis result corresponding to the output of highest evaluation among a plurality of analysis results obtained by analyzing a plurality of past outputs of the person by the output destination analyzing unit.

25. The analysis device according to claim 20, wherein
the computer further comprises an output destination analyzing unit configured to analyze information of a destination to which the output is provided, and
the activity state mapping unit determines an output destination mapping axis corresponding to an analysis result of the output destination analyzing unit, and generates the analysis result in which an activity state according to the output destination mapping axis, among the current activity states of the person detected by the activity real state detection unit, and an optimum activity state according to the output destination mapping axis, among the optimum activity states of the person detected by the activity optimum state detection unit, are associated with each other.

26. The analysis device according to claim 20, wherein
the activity state mapping device outputs the analysis result to an analysis result presenting unit.

27. A work state analyzing method performed by a computer connected with an activity measuring device and an output measuring device, the activity measuring device being configured to measure an activity of a person existing in an area, the output measuring device being configured to measure an output generated by the activity of the person, the method comprising:
detecting a current activity state of the person, based on a measurement result by the activity measuring device;
detecting an optimum activity state from among a plurality of past activity states of the person causing the output to be generated, based on past measurement results by the activity measuring device and the output measuring device; and
generating an analysis result in which the detected current activity state of the person is associated with the optimum activity state.

28. The work state analyzing method according to claim 27, wherein
the computer is connected with an activity tendency measuring device configured to measure preference in activities of the person, and
the generating the analysis result includes generating an analysis result in which the current activity state of the person is associated with the optimum activity state and the preference in activities of the person.

29. The work state analyzing method according to claim 27, wherein
the computer is connected with a mapping axis determination unit configured to determine a mapping axis that is a viewpoint of analysis, and
the generating the analysis result includes generating an analysis result in which an activity state according to the determined mapping axis, among the current activity states of the person detected by the activity real state detection unit, and an optimum activity state according to the determined mapping axis, among the optimum activity states of the person detected by the activity optimum state detection unit, are associated with each other.

30. The work state analyzing method according to claim 27, further comprising by the computer, analyzing the output from a predetermined viewpoint, wherein
the detecting the current activity state of the person includes detecting, as the current activity state of the person, a result of analyzing the measured output from the predetermined viewpoint, and
the detecting the optimum activity state of the person includes detecting, as the optimum activity state of the person, an analysis result corresponding to the output of highest evaluation among a plurality of analysis results obtained by analyzing a plurality of past outputs of the person from the predetermined viewpoint.
